(19) United States
(12) Patent Application Publication
(10) Pub. No.: US 2013/0143564 A1
(43) Pub. Date: Jun. 6, 2013

(54) APPARATUS AND METHOD FOR PERFORMING VOICE COMMUNICATION IN MOBILE TERMINAL

(71) Applicant: Samsung Electronics Co., Ltd., Gyeonggi-do (KR)

(72) Inventor: Dong-Ha KIM, Gyeongsangbuk-do (KR)

(73) Assignee: SAMSUNG ELECTRONICS CO., LTD., Gyeonggi-do (KR)

(21) Appl. No.: 13/691,951

(22) Filed: Dec. 3, 2012

(30) Foreign Application Priority Data
Dec. 2, 2011 (KR) 10-2011-0128472

(51) Int. Cl. H04W 88/02; H04W 36/08

(52) U.S. Cl. CPC H04W 88/02; H04W 36/08
USPC 455/436; 455/422.1

(57) ABSTRACT

An apparatus and a method for performing a voice communication in a mobile terminal that is in range of more than one base station. The mobile terminal determines whether a request signal for a voice communication is transmitted or received. A first signal strength, or a first electric field intensity of a first base station connected to the mobile terminal and a second signal strength, or a second electric field intensity of a second base station positioned within transmission/reception range the mobile terminal are measured when transmission or reception of a requested signal is performed. There is a comparison of electric field intensities or signal strength. Voice communication is performed through the second base station when the second electric field intensity is larger than the first electric field intensity. The first and second base stations may be one generation apart in terms of support.

### CLAIM OF PRIORITY

This application claims priority under 35 U.S.C. §119(a) from an application entitled “Apparatus And Method For Performing Voice Communication In Mobile Terminal” filed in the Korean Intellectual Property Office on Dec. 2, 2011 and assigned Serial No. 10-2011-0128472, the contents of which are hereby incorporated by reference in its entirety.

### BACKGROUND OF THE INVENTION

1. Field of the Invention

The present invention relates to a mobile terminal. More particularly, the present invention relates to an apparatus and a method for performing a voice communication in a mobile terminal utilizing base stations.

2. Description of the Related Art

A radio access technology (hereinafter, referred to as “RAT”) is a technology that supports mobile terminals. For example, RAT supports mobile terminals capable of accessing a global system for mobile telecommunication (GSM) and/or a universal mobile telecommunication system (UMTS), which are a second generation mobile communication system and a third generation mobile communication system that are used in Europe.

In a network supporting multiple mobile terminals, for example, all of the second and third generation mobile communication systems, when a network mode is set as an auto network mode in which all of the second and third generation mobile communication systems may be used, in the case where the intensity of the electric field of a signal received from a base station is not reduced to less than a predetermined level, the mobile terminal communicates using the third generation mobile communication system, which is typically a default to use the latest generation.

On the other hand, when use of the mobile terminal is not for data service or Internet access, and is only being used for voice communication, the battery consumption of the mobile terminal is smaller using the second generation mobile communication system than when the third generation mobile communication system is used.

Therefore, in order to reduce the battery consumption of the mobile terminal, by performing the voice communication using the second generation mobile communication system and not the third generation mobile communication system, contributes to such energy savings.

### SUMMARY OF THE INVENTION

Accordingly, an aspect of the present invention is to solve at least some of the above-mentioned problems, and to provide an apparatus and a method for performing a voice communication using second and third generation mobile communication systems in order to reduce the amount of the battery consumption of a mobile terminal.

In accordance with an exemplary aspect of the present invention, there is provided an apparatus for performing a voice communication in a mobile terminal, that may preferably include an RF unit configured for transmitting or receiving a request signal for the voice communication and a controller configured for checking whether or not the request signal is transmitted or received, for measuring first electric field intensity of a first base station connected to the mobile terminal and second electric field intensity of a second base station positioned around (e.g. within transmission/reception range of) the mobile terminal, particularly when it is determined that transmission or reception of the request signal is being performed, for comparing the first electric field intensity with the second electric field intensity, and for performing the voice communication through the second base station when the second electric field intensity is larger than the first electric field intensity as a result of the comparison. The first base station supports a specific mobile communication system operating at a particular generation of transmission. The second base station supports a mobile communication system of a generation prior to the particular generation of the specific mobile communication system by at least one generation. In other words, the second base station operates at a previous or older (down-level) generation of the particular level of the first base station.

In accordance with another exemplary aspect of the present invention, there is provided a method of performing a voice communication in a mobile terminal The method includes checking whether a request signal for the voice communication is transmitted or received. The method includes measuring a first electric field intensity of a first base station connected to the mobile terminal and a second electric field intensity of a second base station positioned within transmission/reception range of the mobile terminal when a controller determines that one of transmission and reception of the request signal is performed. The first electric field intensity is compared with the second electric field intensity. Voice communication is performed through the second base station when the second electric field intensity is comparatively larger than the first electric field intensity. The first base station supports a specific mobile communication system that is the state of the art in terms of generation. The second base station supports a mobile communication system of a generation prior to the current state of the art generation of the specific mobile communication system by one generation.

According to the present invention, the voice communication is performed using the second generation mobile communication system, even when the third generation system is available, in order to reduce the amount of battery consumption by the mobile terminal. Advantageously, the battery usage can be conserved by using the second generation system for voice communication, and when utilizing other functions that are more efficient or required to use the third generation system, the mobile terminal can use the latest generation.

### BRIEF DESCRIPTION OF THE DRAWINGS

The above and other exemplary aspects, features and advantages of the present invention will become more apparent to a person of ordinary skill in the art from the following detailed description taken in conjunction with the accompanying drawings, in which:

FIG. 1 is a block diagram of a communication system according to an exemplary embodiment of the present invention;

FIG. 2 is a block diagram of a mobile terminal according to the exemplary embodiment of the present invention;

FIG. 3 is a flowchart illustrating exemplary operation of processes of a communication system according to a first exemplary embodiment of the present invention performing a voice communication;

FIG. 4 is a flowchart illustrating exemplary operation of processes of a mobile terminal according to the first exemplary embodiment of the present invention performing a voice communication;

FIG. 5 is a flowchart illustrating exemplary operation of processes of a communication system according to a second exemplary embodiment of the present invention performing a voice communication;

FIG. 6 is a flowchart illustrating exemplary operation of processes of a mobile terminal according to the second exemplary embodiment of the present invention performing a voice communication; and

FIG. 7 is a screen for setting a voice communication method according to the exemplary embodiment of the present invention.

### DETAILED DESCRIPTION

Hereinafter, exemplary embodiments of the Apparatus and Method For Voice Communication according to the present invention will be described with reference to the accompanying drawings. In the following description, a detailed description of known functions and configurations incorporated herein may be omitted when their inclusion could obscure appreciation of the subject matter of the present invention by a person of ordinary skill in in the art with such known functions and configurations.

The present invention proposes a mobile terminal that as a movable electronic device can be easily carried and may comprise, for example, a video telephone, a mobile telephone, a smart phone, an international mobile telecommunication (IMT) 2000 terminal, a wideband code division multiple access (WCDMA) terminal, a universal mobile telecommunication service (UMTS) terminal, a personal digital assistant (PDA), a portable multimedia player (PMP), a digital multimedia broadcasting (DMB) terminal, an E-book, a mobile computer (such as a notebook and a tablet) or a digital camera, just to name a few possibilities.

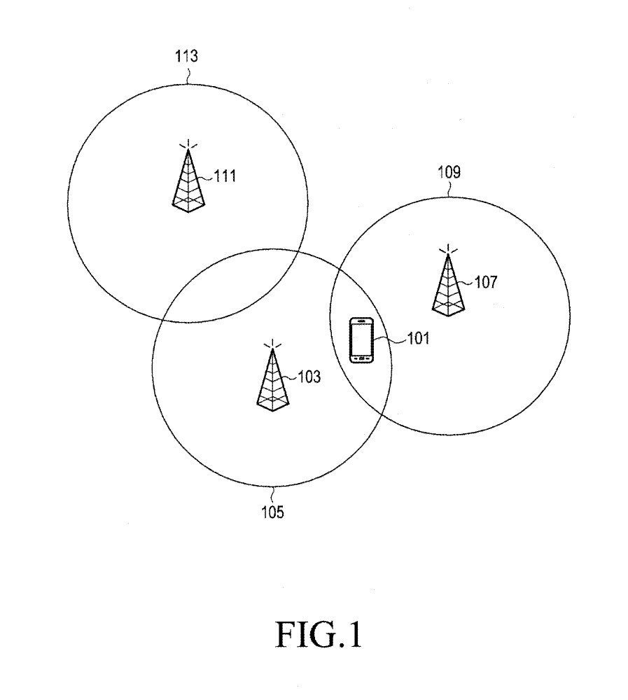

FIG. 1 is an illustration of a communication system according to an exemplary embodiment of the present invention.

Referring now to FIG. 1, the communication system includes first to third base stations 103, 107, and 111 and a mobile terminal 101.

More particularly, the first base station 103 includes a first cell region 105, the second base station 107 includes a second cell region 109, and the third base station 111 includes a third cell region 113. For the purposes of this example, the first base station 103 and the third base station 111 support the same mobile communication system and the second base station 107 supports a different mobile communication system from the mobile communication system supported by the first base station 103 and the third base station 111.

The first base station 103 performs a handover to the second base station 107 in accordance with the handover request of the mobile terminal 101 and transmits a voice signal received from a mobile terminal (not shown) of the other party to the mobile terminal 101, or transmits a voice signal received from the mobile terminal 101 to the mobile terminal (not shown) of the other party. The second base station 107 performs a handover to the first base station 103 in accordance with the handover request of the mobile terminal 101 and transmits a voice signal received from a mobile terminal (not shown) of the other party to the mobile terminal 101 or transmits a voice signal received from the mobile terminal 101 to the mobile terminal (not shown) of the other party.

In this particular example, the first base station 103 and the third base station 111 support a more developed (advanced) mobile communication system than a mobile communication system supported by the second base station 107. For example, the first base station 103 and the third base station 111 may support a third generation mobile communication system and the second base station 107 may support a second generation mobile communication system.

Here, in this particular example, the third generation mobile communication system refers to the third generation of a mobile communication technology. The third generation mobile communication technology includes universal mobile telecommunication system (hereinafter, referred to as UMTS), code division multiple access (hereinafter, referred to as CDMA) 2000, and time division synchronous CDMA (TD-SCDMA). A service provided by the third generation mobile communication system may transmit/receive voice data and/or non-voice data (for example, downloading data, sending and receiving a mail, and sending a message).

The second generation mobile communication system refers to a mobile communication system of a digital method. The second generation mobile communication technology includes IS-136 time division multiple access (hereinafter, referred to as TDMA), global system for mobile communication (GSM)/general packet radio service (GPRS), and IS-95 CDMA. A service provided by the second generation mobile communication system may transmit/receive voice data and low capacity non-voice data at low speed.

With continued reference to FIG. 1, the mobile terminal 101 is positioned in a region where the first cell region 105 and the second cell region 109 overlap each other and supports both the mobile communication system supported by the first base station 103 and the mobile communication system supported by the second base station 107. For example, when the first base station 103 supports the third generation mobile communication system and the second base station 107 supports the second generation mobile communication system, the mobile terminal 101 may be capable of supporting both the second generation mobile communication system and the third generation mobile communication system.

In particular, when the mobile terminal 101 performs an operation for a voice communication, in the case where the intensity of the electric field of the second base station 107 is larger than the intensity of the electric field of the first base station 103, the mobile terminal 101 transmits/receives a voice signal for the voice communication through the second base station 107 to reduce the power consumption of a battery during the voice communication.

For example, in the case where the first base station 103 supports the third generation mobile communication system and the second base station 107 supports the second generation mobile communication system, the amount of current consumed by the battery when the mobile terminal 101 performs the voice communication through the first base station 103 may be, for example, 250 mA and current consumed by the battery when the mobile terminal 101 performs the voice communication through the second base station 107 may be, for example, 100 mA.

Therefore, the mobile terminal 101 performs the voice communication through the second base station 107 rather than the first base station 103 to reduce the current consumption of the battery.

Describing the above in more detail, when the user of the mobile terminal 101 requests performance of the voice communication, the mobile terminal 101 performs a communication with the first base station 103 and measures the first electric field intensity of the first base station 103 and the second electric field intensity of the second base station 107 to compare the first electric field intensity with the second electric field intensity. As a result of the comparison of electric field strengths, when the second electric field intensity is larger than the first electric field intensity, the mobile terminal 101 performs a handover from the first base station 103 to the second base station 107 and performs a connection for the voice communication through the second base station 107. Unlike the above example where the second electric field intensity is no larger than the first electric field intensity, the mobile terminal 101 performs a connection for the voice communication through the first base station 103. When it is requested to complete the voice communication, the mobile terminal 101 performs a handover from the second base station 107 to the first base station 103 and cancels a connection for the voice communication.

For example, the first electric field intensity and the second electric field intensity that are a basis for comparison may include at least one of a carrier to interference ratio (CINR), a signal to noise ratio (SNR), and a signal to interference plus noise ratio (SINR).

According to an exemplary embodiment of the present invention, when a voice call signal is received, the mobile terminal 101, which performs a communication with the first base station 103, performs a connection for the voice communication through the first base station 103. Here, the voice call signal represents that a mobile terminal (not shown) of the other party desires to perform the voice communication with the mobile terminal 101. The mobile terminal 101 measures the first electric field intensity of the first station 103 and the second electric field intensity of the second base station 107 during the voice communication and compares the first electric field intensity with the second electric field intensity. As a result of the comparison of electric field intensity, when the second electric field intensity is larger than the first electric field intensity, the mobile terminal 101 performs a handover from the first base station 103 to the second base station 107 and performs a connection for the voice communication through the second base station 107. Unlike in the above, when the second electric field intensity is not larger than the first electric field intensity, the mobile terminal 101 performs a connection for the voice communication through the first base station 103. When it is requested to complete the voice communication, the mobile terminal 101 performs a handover from the second base station 107 to the first base station 103 and cancels a connection for the voice communication.

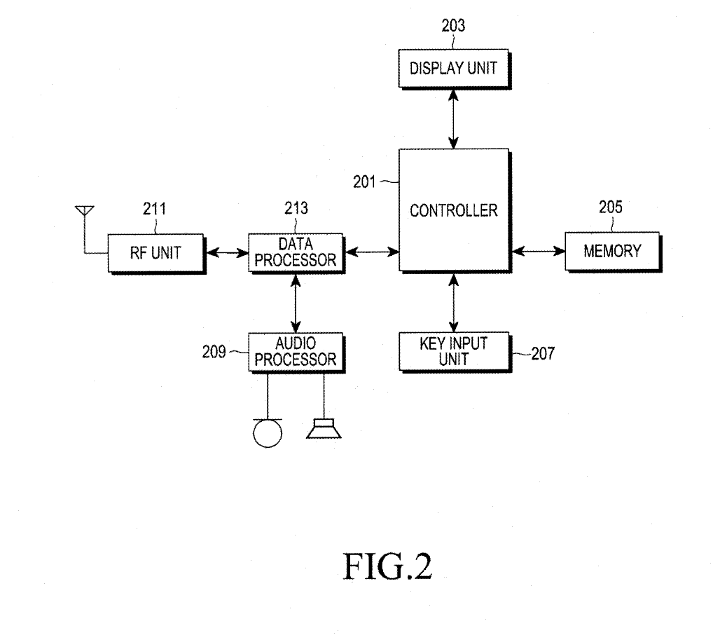

FIG. 2 is a block diagram of a mobile terminal according to the exemplary embodiment of the present invention.

Referring now to FIG. 2, the mobile terminal 101 preferably includes a controller 201, a display unit 203, a key input unit 207, a memory 207, an audio processor 209, an RF unit 211, and a data processor 213.

More particularly, the RF unit 211 performs the radio communication function of the mobile terminal 101. For example, the RF unit 211 includes a radio transmitter for up converting and amplifying the frequency of a transmitted signal and a radio receiver for low noise amplifying a received signal and down converting the frequency of the received signal. The data processor 213, which includes a transmitter for encoding and modulating the transmitted signal and a receiver for demodulating and decoding the received signal. The data processor 213 may include a modem and a codec. The codec may include a data codec for processing packet data and an audio codec for processing an audio signal such as a voice.

The audio processor 209 reproduces a received audio signal output from the data processor 213 through a speaker or transmits a transmitted audio signal generated by a mike to the data processor 213. The key input unit 205 includes keys for inputting number and character information items and functional keys for setting various functions, or may constitute a virtual keyboard. The display unit 203 displays an image signal on a screen and displays data requested to be output from the controller 201.

When the display unit 203 is realized by a touch display screen method, such as, for example, a capacitive method or an impact method, the key input unit 205 may include only previously set minimum keys and the display unit 203 may partially or even completely replace the key input function of the key input unit 205.

The memory 207, which comprises a non-transitory machine readable medium, includes a program memory and a data memory. The program memory stores a booting system and an operating system (hereinafter, referred to as OS) for controlling the common operation of the mobile terminal 101. The data memory stores various data items generated during the operation of the mobile terminal 101.

The controller 201, which is comprised of hardware such as a processor or microprocessor, is preferably configured to control the entire operation of the mobile terminal 101. In particular, the controller 201 controls performance of the voice communication through the second base station 107 to reduce the consumption of the battery of the mobile terminal 101.

More particularly, when the mobile terminal 101 requests voice communication while the mobile terminal 101 is already performing a communication function with the first base station 103, the controller 201 measures the first electric field intensity of the first base station 103 and the second electric field intensity of the second base station 107 to compare the first electric field intensity with the second electric field intensity. As a result of the comparison, when the second electric field intensity is larger than the first electric field intensity, the controller 201 performs a handover from the first base station 103 to the second base station 107 and performs a connection for the voice communication through the second base station 107. When it is requested to complete the voice communication, the controller 201 performs a handover from the second base station 107 to the first base station 103 and cancels a connection for the voice communication. Unlike in the above example, when the second electric field intensity is not larger than the first electric field intensity, the mobile terminal 101 performs a connection for the voice communication through the first base station 103. When it is requested to complete the voice communication, the mobile terminal 101 cancels a connection for the voice communication.

When the controller 201 receives a voice call signal while the mobile terminal 101 is performing a communication with the first base station 103, the controller 201 performs a connection for the voice communication through the first base station 103. Here, the voice call signal represents that a mobile terminal (not shown) of the other party desires to perform the voice communication with the mobile terminal 101. The controller 201 measures the first electric field intensity of the first station 103 and the second electric field intensity of the second base station 107 during the voice communication and compares the first electric field intensity with the second electric field intensity. As a result of comparison, when the second electric field intensity is larger than the first electric field intensity, the controller 201 performs a handover from the first base station 103 to the second base station 107 and performs a connection for the voice communication through the second base station 107. When it is requested by the user or the mobile terminal of the other party to complete the voice communication, the controller 201 performs a handover from the second base station 107 to the first base station 103 and cancels a connection for the voice communication. Unlike in the above example, when the second electric field intensity is not larger than the first electric field intensity, the controller 201 performs a connection for the voice communication through the first base station 103. When it is requested by the user or the mobile terminal of the other party to complete (end) the voice communication (terminate the voice call), the controller 201 cancels a connection for the voice communication.

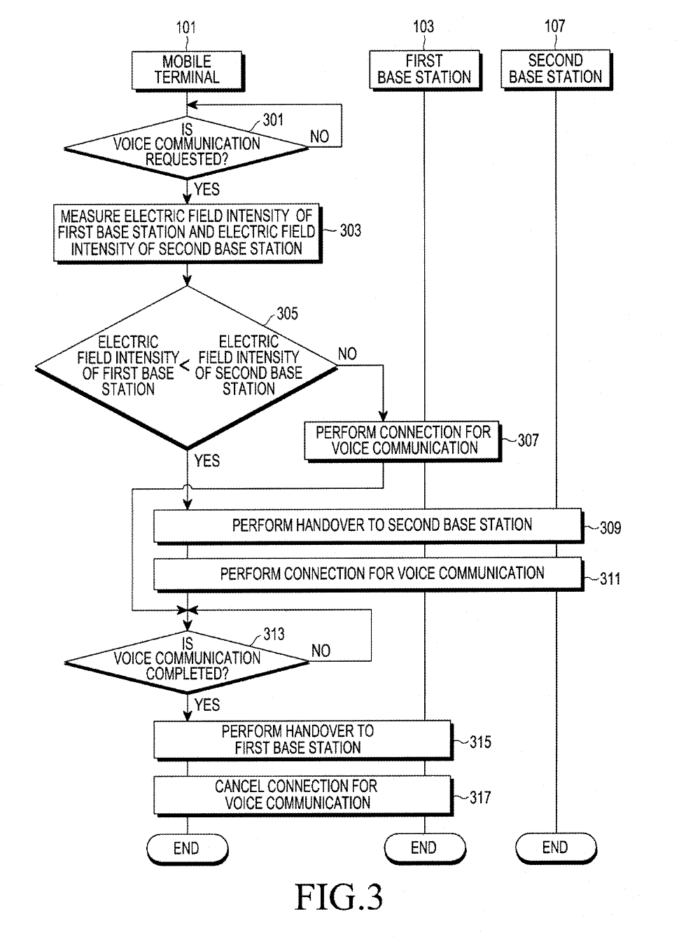

FIG. 3 is a flowchart illustrating exemplary processes of a communication system according to a first exemplary embodiment of the present invention performing a voice communication. An artisan should understand and appreciation that the controller of the mobile terminal is configured preferably to perform or control performance of all of the determinations in the method steps.

Referring now to FIG. 3, in step 301, the mobile terminal 101 performs a communication with the first base station 103 checks whether there is a request to perform a voice communication. When there is a request to perform voice communication, the mobile terminal 101 performs step 303 by measuring the first electric field intensity of the first base station 103 and the second electric field intensity of the second base station 107. When t step 301, there is no request for voice communication, the mobile terminal 101 waits for such a request.

At step 305, the mobile terminal 101 compares the first electric field intensity with the second electric field intensity. As a result of the comparison, when the second electric field intensity is larger than the first electric field intensity, the mobile terminal 101 performs step 309. When the second electric field intensity is not larger than the first electric field intensity, the mobile terminal 101 performs a connection for the voice communication with a mobile terminal of the other party through the first base station 103 and then performs step 313.

The mobile terminal 101 performs step 309 by requesting performance of a handover from the first base station 103 to the second base station 107, and then performs step 311.

More particularly, the mobile terminal 101 transmits a handover request message to the second base station 107 and receives a handover response message from the second base station 107. The handover request message includes information that requests a handover. The handover response message as a response to the handover request message includes information that represents whether a corresponding base station may perform the handover. The mobile terminal 101 receives the handover response message from the second base station 107 and analyzes the received handover response message to determine whether the second base station 107 may perform the requested handover. When the mobile terminal determines that the second base station 107 may perform the handover, the mobile terminal 101 performs a handover process with the second base station 107 through the first base station 103.

In the step 311, the mobile terminal 101 performs a connection for the voice communication through the second base station 107 and performs step 313.

At step 313, the mobile terminal 101 checks whether or not the mobile terminal of the other party has requested completion of the voice communication. When the mobile terminal 101 determines that there is a request to complete the voice communication, the mobile terminal 101 performs step 315. When the mobile terminal 101 determines that there is no request to complete the voice communication, the mobile terminal 101 repetitively performs the step 313.

When the mobile terminal 101 performs step 315, the mobile terminal 101 performs a handover with the first base station 103 and then proceeds to perform step 317. In more detail, when a connection for the voice call is performed through the first base station 103, the mobile terminal 101 does not perform a handover to the first base station 103 but instead proceeds to perform step 317. When a connection for the voice call is performed through the second base station 107, the mobile terminal 101 performs a handover from the second base station 107 to the first base station 103 and proceeds to perform step 317.

At step 317, the mobile terminal 101 cancels a connection of the voice communication to the first base station 103.

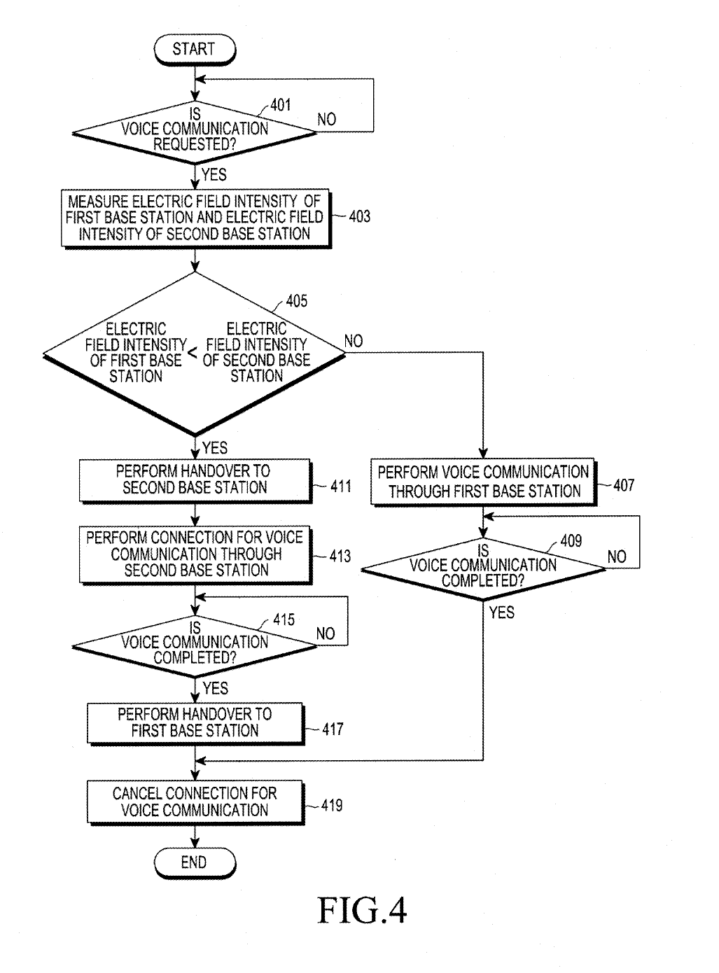

FIG. 4 is a flowchart illustrating processes of a mobile terminal according to the first exemplary embodiment of the present invention performing a voice communication.

Referring now to FIG. 4, at step 401, the mobile terminal 10, which performs a communication with the first base station 103, checks whether there is a request to perform a voice communication. When it is requested to perform the voice communication, the mobile terminal 101 proceeds to perform to step 403. When there is no request by the user to perform the voice communication, the mobile terminal 101 proceeds to perform step 401.

When the mobile terminal 101 proceeds to perform step 403, the mobile terminal 101 measures the first electric field intensity of the first base station 103 and the second electric field intensity of the second base station 107 and proceeds to perform step 405. In the step 405, the mobile terminal 101 compares the first electric field intensity with the second electric field intensity. As a result of the comparison, when the second electric field intensity is larger than the first electric field intensity, the mobile terminal 101 proceeds to perform step 411. When the second electric field intensity is not larger than the first electric field intensity, the mobile terminal 101 proceeds to perform step 407.

When the mobile terminal 101 performs step 407, the mobile terminal 101 performs a connection for the voice communication with a mobile terminal of the other party through the first base station 103 and then performs step 409. At step 409, the mobile terminal 101 checks whether there is a request by its user, or the mobile terminal of the other party, to complete the voice communication. When the mobile terminal determines there is a request to complete (e.g. end) the voice communication, the mobile terminal 101 performs step 419. When the mobile terminal determines that there is no request to end the voice communication, the mobile terminal 101 repetitively performs the step 409.

When the mobile terminal 101 performs step 411, the mobile terminal 101 performs a handover from the first base station 103 to the second base station 107 and then proceeds to perform step 413. In step 413, the mobile terminal 101 performs a connection for the voice communication through the second base station 107 and proceeds to step 415.

In the step 415, the mobile terminal 101 checks whether it is requested by the user or the mobile terminal of the other party to complete the voice communication. When the mobile terminal determines that it is requested to complete the voice communication, the mobile terminal 101 performs step 417. When the mobile terminal determines there is no request to complete the voice communication, mobile terminal 101 repetitively performs step 415.

When the mobile terminal performs step 417, the mobile terminal 101 performs a handover to the first base station 103 and then performs step 419. In the step 419, the mobile terminal 101 cancels a connection for the voice communication with the first base station 103.

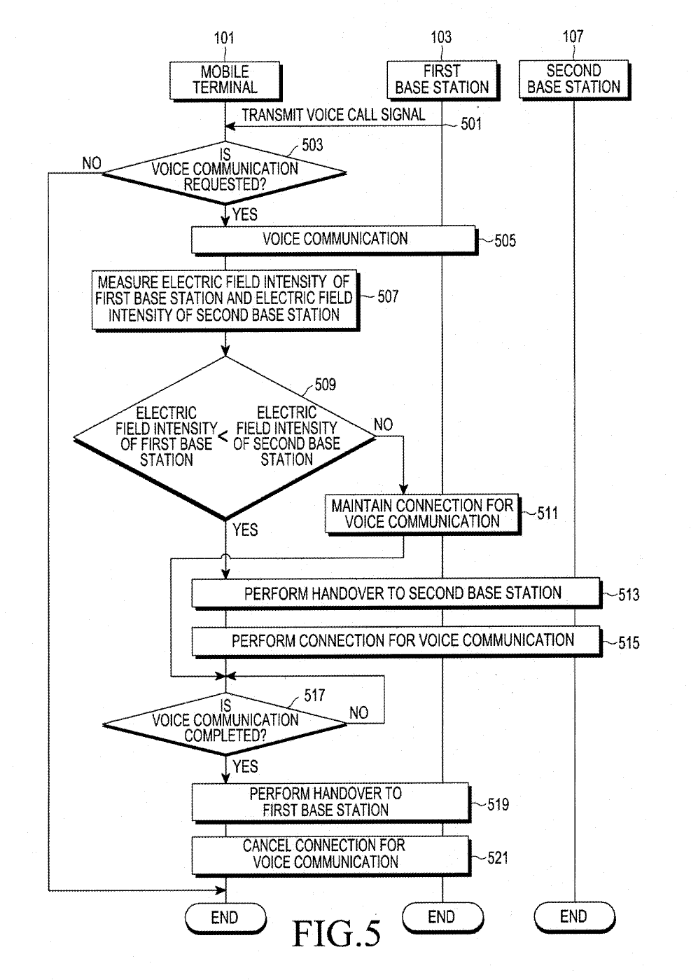

FIG. 5 is a flowchart illustrating exemplary processes of a communication system according to a second exemplary embodiment of the present invention performing a voice communication.

Referring now to FIG. 5, in step 501, the mobile terminal 101 that performs a communication with the first base station 103 receives a voice communication signal from the first base station 103 and proceeds to perform step 503. Here, the voice communication signal represents that a mobile terminal (not shown) of the other party desires to perform a voice communication with the mobile terminal 101.

In the step 503, the mobile terminal 101 checks whether there is a request to perform a connection for the voice communication. When it is determined by the mobile terminal that there is a request to perform a connection for the voice communication, the mobile terminal 101 performs step 505. When the mobile terminal determines that there is no request to perform a connection for the voice communication, the mobile terminal 101 completes a process of performing a connection for the voice communication.

When the mobile terminal 101 performs step 505, the mobile terminal 101 performs a connection for the voice communication through the first base station 103 and then performs step 507.

In the step 507, the mobile terminal 101 measures the first electric field intensity of the first base station 103 and the second electric field intensity of the second base station 107 and then performs. In the step 509, the mobile terminal 101 compares the first electric field intensity with the second electric field intensity. As a result of comparison, when the second electric field intensity is larger than the first electric field intensity, the mobile terminal 101 performs step 513. When the second electric field intensity is not larger than the first electric field intensity, the mobile terminal 101 performs step 511.

When the mobile terminal 101 performs step 511, the mobile terminal 101 continuously maintains a connection for the voice communication with the mobile terminal of the other party through the first base station 103 and proceeds to perform step 517.

When the mobile terminal 101 performs step 513, the mobile terminal 101 performs a handover from the first base station 103 to the second base station 107 and then performs step 515.

In more detail, the mobile terminal 101 transmits a handover request message to the second base station 107 and receives a handover response message from the second base station 107. The handover request message includes information that requests a handover. The handover response message comprises a response to sender of the handover request message that includes information representing whether a corresponding base station may perform the handover. The mobile terminal 101 receives the handover response message from the second base station 107 and analyzes the received handover response message to determine whether the second base station 107 may perform the handover. When the mobile terminal determines that the second base station 107 may perform the handover, the mobile terminal 101 performs a handover process with the second base station 107 through the first base station 103.

With continued reference to FIG. 5, at step 515, the mobile terminal 101 performs a connection for the voice communication through the second base station 107 and proceeds to the step 517.

In the step 517, the mobile terminal 101 determines whether or not there is a request by the user or the mobile terminal of the other party to complete the voice communication. When the mobile terminal determines that it is requested to complete the voice communication, the mobile terminal 101 proceeds to perform step 519. When the mobile terminal determines that there is no request to complete the voice communication, so the mobile terminal 101 repetitively performs step 517.

When the mobile terminal 101 performs step 519, the mobile terminal 101 performs a handover to the first base station 103 and proceeds to step 521. In more detail, when a connection for the voice call is performed through the first base station 103, the mobile terminal 101 does not perform a handover to the first base station 103 but performs step 521. When a connection for the voice call is performed through the second base station 107, the mobile terminal 101 performs a handover from the second base station 107 to the first base station 103 and then performs step 521.

At step 521, the mobile terminal 101 cancels a connection of the voice communication with the first base station 103.

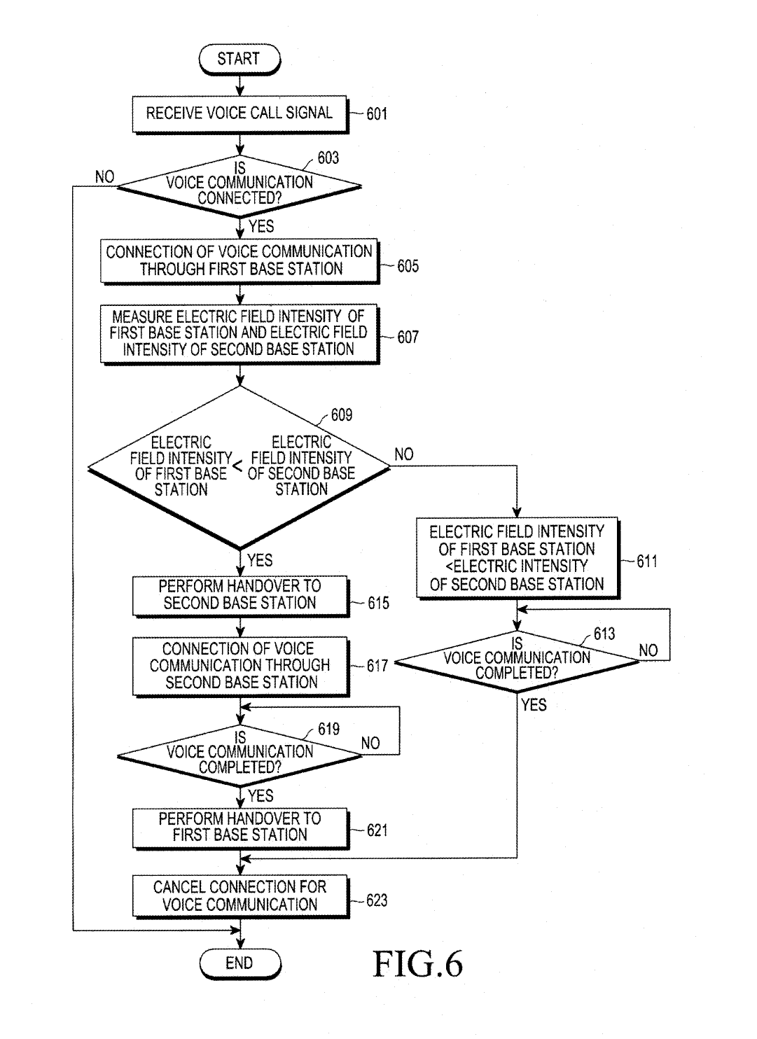

FIG. 6 is a flowchart illustrating exemplary processes of a mobile terminal according to the second exemplary embodiment of the present invention performing a voice communication.

Referring now to FIG. 6, at step 601, the mobile terminal 101 performs a communication with the first base station 103, and after receiving a voice call signal and then performs step 603. At step 603, 603, the mobile terminal 101 checks whether there is a request from a user to perform a connection for the voice communication. When the mobile terminal determines that there is a request to perform a connection for the voice communication, the mobile terminal 101 performs step 605. When it is determined that there is no request to perform a connection for the voice communication, the mobile terminal 101 completes a process of performing a connection for the voice communication.

When the mobile terminal 101 performs step 605, the mobile terminal 101 measures the first electric field intensity of the first base station 103 and the second electric field intensity of the second base station 107 and then performs step 607. In the step 607, the mobile terminal 101 compares the first electric field intensity with the second electric field intensity. As a result of the comparison, when the second electric field intensity is larger than the first electric field intensity, the mobile terminal 101 performs step 615. When the second electric field intensity is not larger than the first electric field intensity, the mobile terminal 101 performs step 611.

When the mobile terminal 101 performs step 611, the mobile terminal 101 performs a connection for the voice communication with the mobile terminal of the other party through the first base station 103 and then performs step 613. At step 613, the mobile terminal 101 checks whether there is a user request or a request by the mobile terminal of the other party to complete the voice communication. When the mobile terminal determines that there is a request to complete the voice communication, and then the mobile terminal 101 performs step 623. When the mobile terminal determines that there is no request to complete the voice communication, the mobile terminal 101 repetitively performs step 613.

When the mobile terminal 101 performs step 615, the mobile terminal 101 performs a handover from the first base station 103 to the second base station 107 and performs step 617. At step 617, the mobile terminal 101 performs a connection for the voice communication through the second base station 107 performs step 619.

At step 619, the mobile terminal 101 checks whether there is a request by the user or the mobile terminal of the other party to complete the voice communication. When the mobile terminal determines that there is a request to complete the voice communication, the mobile terminal 101 performs step 621. When the mobile terminal determines that there is no request to complete the voice communication, and the mobile terminal 101 repetitively performs step 619.

When the mobile terminal 101 performs step 621, the mobile terminal 101 performs a handover to the first base station 103 and then performs step 623. In the step 623, the mobile terminal 101 cancels a connection for the voice communication with the first base station 101.

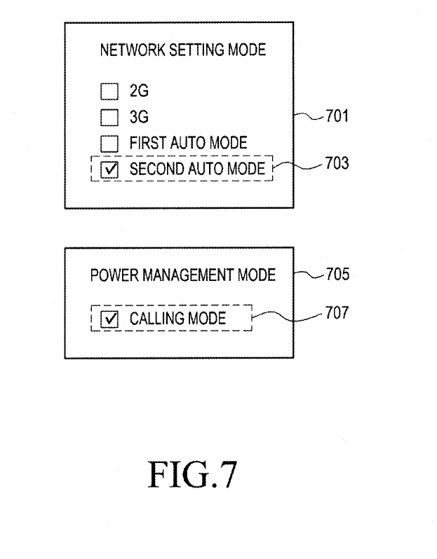

FIG. 7 is a screen for setting a voice communication method according to another exemplary embodiment of the present invention.

Referring now to FIG. 7, a first screen 701 represents the network setting mode of the mobile terminal 101 including the following four setting modes.

In a second generation (2G) mode, the mobile terminal 101 supports only a second generation mobile communication system. In a 3G mode, the mobile terminal 101 supports only a third generation mobile communication system.

In a first auto mode, the mobile terminal 101 supports both the second generation mobile communication system and the third generation mobile communication system. Describing the above in more detail, in the first auto mode, when the electric field intensity of the first base station that supports the third generation mobile communication system is not larger than a predetermined reference value, the mobile terminal 101 performs a voice communication through the second base station that supports the second mobile communication system.

In a second auto mode 703, according to the present invention, the mobile terminal 101 supports both the second generation mobile communication system and the third generation mobile communication system. Describing the above in more detail, in the second auto mode 703, when the electric field intensity of the second base station that supports the second generation mobile communication system is larger than the electric field intensity of the first base station that supports the third generation mobile communication system, the mobile terminal 101 performs the voice communication through the second base station.

When the second auto mode 703 is selected for operation, the mobile terminal 101 may perform the voice communication through one of the first base station and the second base station in accordance with a comparison result between the electric field intensity of the first base station and the electric field intensity of the second base station.

A second screen 705 represents the power management mode of the mobile terminal 101. In a calling mode 707 according to the present invention, when the electric field intensity of the second base station that supports the second generation mobile communication system is larger than the electric field intensity of the first base station that supports the third generation mobile communication system, the mobile terminal 101 performs the voice communication through the second base station.

When the calling mode 707 is selected, the mobile terminal 101 may perform the voice communication through one of the first base station and the second base station in accordance with a comparison result between the electric field intensity of the first base station and the electric field intensity of the second base station.

As described above, according to the present invention, the mobile terminal 101 performs the voice communication through the second base station that supports the second generation mobile communication system instead of the first base station that supports the third generation mobile communication system so that the consumption amount of the battery of the mobile terminal 101 may be reduced.

While the invention has been shown and described with reference to certain exemplary embodiments thereof such as a mobile communication terminal, it will be understood by those skilled in the art that various changes in form and details may be made therein without departing from the spirit and scope of the invention as defined by the appended claims.

The above-described methods according to the present invention can be implemented in hardware, firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

The terms “unit” or “module” as used herein is to be understood as constituting hardware such as a processor or microprocessor configured for a certain desired functionality in accordance with statutory subject matter under 35 U.S.C. §101 and does not constitute software per se.

The present invention has been described with respect to particular embodiments and with reference to certain drawings, but the invention is not limited thereto, but rather, is set forth only by the claims The drawings described are only schematic and are non-limiting. In the drawings, for illustrative purposes, the size of some of the elements may be exaggerated and not drawn to a particular scale. Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present invention, the only relevant components of the device are A and B.

Furthermore, the terms “first”, “second”, “third” and the like, if used in the description and in the claims, are provided for distinguishing between similar elements and not necessarily for describing a sequential or chronological order. It is to be understood that the terms so used are interchangeable under appropriate circumstances (unless clearly disclosed otherwise) and that the embodiments of the invention described herein are capable of operation in other sequences and/or arrangements than are described or illustrated herein.

What is claimed is:

1. An apparatus for performing a voice communication in a mobile terminal, comprising:
an RF unit for transmitting or receiving a request signal for the voice communication; and
a controller configured for checking whether the request signal is transmitted or received by the RF unit, for measuring a first electric field intensity of a first base station connected to the mobile terminal and a second electric field intensity of a second base station positioned within transmission/reception range of the mobile terminal when determining that at least one of a transmission and a reception of the request signal is performed, for comparing the first electric field intensity with the second electric field intensity, and for performing the voice communication through the second base station when the second electric field intensity is larger than the first electric field intensity as a result of the comparison,
wherein the first base station supports a specific mobile communication system of a particular generation and the second base station supports a mobile communication system of a generation prior to the particular generation of the specific mobile communication system by one generation.

2. The apparatus for performing a voice communication as claimed in claim 1, wherein the particular generation supported by the first base station comprises a third generation mobile communication system and the communication system of a generation prior to the particular generation supported by the second base station comprises a second generation mobile communication system.

3. The apparatus for performing a voice communication as claimed in claim 1, wherein the first electric field intensity and the second electric field intensity that are compared comprise one of a carrier to interference ratio (CINR), a signal to noise ratio (SNR), and a signal to interference plus noise ratio (SINR).

4. The apparatus for performing a voice communication as claimed in claim 1, wherein the controller measures the first electric field intensity and the second electric field intensity when the request signal is transmitted, compares the first electric field intensity with the second electric field intensity, performs a handover from the first base station to the second base station when a value of the second electric field intensity is larger than the first electric field intensity as a result of the comparison, and performs a connection for the voice communication through the second base station.

5. The apparatus for performing a voice communication as claimed in claim 4, wherein the controller performs a handover from the second base station to the first base station when there is a request signal to complete the voice communication, and cancels a connection for the voice communication through the first base station.

6. The apparatus for performing a voice communication as claimed in claim 1, wherein the controller performs a connection for the voice communication through the first base station when the request signal is received and measures the first electric field intensity and the second electric field intensity.

7. The apparatus for performing a voice communication as claimed in claim 6, wherein the controller performs a handover from the first base station to the second base station when the second electric field intensity is larger than the first electric field intensity and performs a connection for the voice communication through the second base station.

8. The apparatus for performing a voice communication as claimed in claim 7, wherein the controller performs a handover from the second base station to the first base station when there is a request signal to complete the voice communication and cancels a connection for the voice communication through the first base station.

9. A method of performing a voice communication in a mobile terminal, comprising:
checking by a controller whether a request signal for a voice communication is transmitted or received by an RF unit;
measuring by the controller a first electric field intensity of a first base station connected to the mobile terminal and a second electric field intensity of a second base station positioned within transmission/reception range the mobile terminal when determining that at least one of a transmission and a reception of the request signal is performed;
comparing by the controller the first electric field intensity with the second electric field intensity; and
performing the voice communication by the controller through the second base station when the second electric field intensity is larger than the first electric field intensity as a result of the comparison of respective first and second electric field intensities,
wherein the first base station supports a specific mobile communication system of a particular generation and the second base station supports a mobile communication system of a generation prior to the particular generation of the specific mobile communication system by one generation.

10. The method of performing a voice communication as claimed in claim 9, wherein the specific mobile communication system of a particular generation supported by the first base station comprises a third generation mobile communication system and the mobile communication system of a generation prior to the particular generation supported by second base station comprises a second generation mobile communication system.

11. The method of performing a voice communication as claimed in claim 9, wherein a measurement of the first electric field intensity and the second electric field intensity comprises one of a carrier to interference ratio (CINR), a signal to noise ratio (SNR), and a signal to interference plus noise ratio (SINR).

12. The method of performing a voice communication as claimed in claim 9, wherein performing of the voice communication by the controller comprises:
when the request signal is transmitted, performing a handover from the first base station to the second base station; and
performing a connection for the voice communication through the second base station.

13. The method of performing a voice communication as claimed in claim 12, further comprising:
when it is requested to complete the voice communication, performing a handover from the second base station to the first base station; and
cancelling a connection for the voice communication through the first base station.

14. The method of performing a voice communication as claimed in claim 9, wherein, in measuring the first electric field intensity and the second electric field intensity, when the request signal is received, the first electric field intensity and the second electric field intensity are measured after performing a connection for the voice communication through the first base station.

15. The method of performing a voice communication as claimed in claim 14, wherein performing of the voice communication by the controller comprises:
when the second electric field intensity is larger than the first electric field intensity, performing a handover from the first base station to the second base station; and
performing a connection for the voice communication through the second base station.

16. The method of performing a voice communication as claimed in claim 15, further comprising:
when it is requested to complete the voice communication, performing a handover from the second base station to the first base station; and
canceling a connection for the voice communication through the first base station.

17. An apparatus for performing a voice communication in a mobile terminal, comprising:
an RF unit for transmitting or receiving a request signal for the voice communication; and
a controller configured for checking whether the request signal is transmitted or received by the RF unit, for measuring a first electric field intensity of a first base station connected to the mobile terminal and a second electric field intensity of a second base station positioned within transmission/reception range of the mobile terminal when determining that at least one of a transmission and a reception of the request signal is performed, for comparing the first electric field intensity with the second electric field intensity, and for performing only the voice communication through the second base station when the second electric field intensity is equal or larger than a predetermined level for voice communication even when the first electric field intensity is greater than the second electric field intensity,
wherein the first base station supports a specific mobile communication system of a particular generation and the second base station supports a mobile communication system of a generation prior to the particular generation of the specific mobile communication system by one generation.

18. A method of performing a voice communication in a mobile terminal, comprising:
checking by a controller whether a request signal for a voice communication is transmitted or received by an RF unit;
measuring by the controller a first electric field intensity of a first base station connected to the mobile terminal and a second electric field intensity of a second base station positioned within transmission/reception range the mobile terminal when determining that at least one of a transmission and a reception of the request signal is performed;
comparing by the controller the first electric field intensity with the second electric field intensity; and
performing only the voice communication through the second base station when the second electric field intensity is equal or larger than a predetermined level for voice communication even when the first electric field intensity is greater than the second electric field intensity,
wherein the first base station supports a specific mobile communication system of a particular generation and the second base station supports a mobile communication system of a generation prior to the particular generation of the specific mobile communication system by one generation.
